(19) United States
(12) Patent Application Publication
(10) Pub. No.: US 2014/0083916 A1
(43) Pub. Date: Mar. 27, 2014

(54) METHOD FOR GRAVITY SEPARATION OF PLASTIC PARTICLES AND GRAVITY SEPARATOR FOR PLASTIC PARTICLES

(71) Applicant: KRONES AG, Neutraubling (DE)

(72) Inventor: Frank Rossen, Trap (DE)

(21) Appl. No.: 14/034,619

(22) Filed: Sep. 24, 2013

(30) Foreign Application Priority Data
Sep. 27, 2012 (DE) 10 2012 217 577.6

(51) Int. Cl. B07B 4/02

(52) U.S. Cl. CPC B07B 4/02
USPC 209/644

(57) ABSTRACT

A method and a device for gravity separation of plastics particles, in particular of plastic flakes, where separation gas is guided upwardly in the counter stream against the plastic particles to be separated. Due to the fact that the separation gas is at least partially ionized, the selectivity of the separation can be increased with low energy input.

### CROSS-REFERENCE TO RELATED APPLICATION

The present application claims the benefit of priority of German Application No. 102012217577.6, filed Sep. 27, 2012. The entire text of the priority application is incorporated herein by reference in its entirety.

### FIELD OF THE DISCLOSURE

The disclosure relates to a method for gravity separation of plastic particles and a gravity separator for plastic particles.

### BACKGROUND

Gravity separation of plastic particles is a widely used method for separating particle collectives under gravity according to size or density of the particles supplied. In particular with plastic particles, the separation into the individual fractions can be impeded by an electrostatic charge of the particles. They can arise, in particular with recycling material, already during the comminution and/or the transport of the plastic particles, as well as during other separation methods. For example, material separation can by means of dosed electrostatic charging occur in preparation of the gravity separation, as is known for the separation of PET particles and PVC particles. However, the plastic particles to be separated can also be passively, i.e. inadvertently, charged to an undesired degree during transportation of the material, for example, by friction of the particles against the pipe wall.

To reduce the interfering electrostatic charges, it is known, for example from U.S. Pat. No. 7,380,670, that the particles are subjected to magnetic fields. However, magnetic fields can not be provided with the required homogeneity in the respective devices or only at great technical effort. Therefore, facility areas usually form, in which the electrostatic charges of the plastic particles are not sufficiently removed, so that they accumulate in the respective areas in an undesired manner. The high energy consumption associated with such methods is also disadvantageous.

There is therefore a need for methods and devices for air separation of plastic particles, in particular of PET (R-PET) returned after use, with which the interfering effects of electrostatic charges can be effectively avoided or at least reduced at minimal energy expenditure.

### SUMMARY OF THE DISCLOSURE

The objective posed is satisfied with a method according to the disclosure, wherein, plastics particles, in particular plastic flakes, can with the aid of separation gas, be guided upwardly in the counter stream to the plastic particles to be separated, be separated following the principle of gravity separation. For this purpose, the separation gas is at least partially ionized. The separation gas is preferably air. During ionization, preferably oxygen molecules present in the air are charged so that positively and negatively charged oxygen ions arise. They can exchange charges in particular with reactants to be oxidized, for example, with organic and/or inorganic substances. Thereby, electrostatic charges of the particles can be neutralized among each other. The plastic flakes preferably comprise recycling material, in particular, shredded PET bottles. Their varying thickness and wall portions usually being stretched to a varying degree can be separated particularly advantageously using the gravity separation according to the disclosure.

Preferably, ionized gas is added to the separation gas, in particular with respect to the main direction of flow of the separation gas in the transverse stream. The ionized gas can also be added as needed at several points of the separation gas stream, so that electrostatic charges of the plastic particles can be effectively and efficiently reduced.

In the transverse stream, the ionized gas can be distributed uniformly and/or across the entire flow cross-section of the separation gas. The main direction of flow of the separation gas can point vertically upwardly, so that it acts as a pure counter stream with respect to the falling direction of the plastic particles, or point obliquely upwardly, so that the separation gas acts according to the conventional definition in combination of a counter stream and a transverse stream. According to the disclosure, the term “counter stream” is defined for the separation gas such, that the counter stream component is always greater than the transverse stream component.

Preferably, the ionized gas is added in at least two transverse streams separately adjustable with respect to their flow rate and/or their main direction of flow. Thereby, the electrostatic charge of the separation gas can be specifically reduced in different areas of the separation gas stream. Consequently, the selectivity of the separation and in particular the separation of the plastic particles into a light fraction and a heavy fraction can be improved.

Preferably, the transverse streams are introduced successively with respect to the main direction of flow of the separation gas. Thereby, the selectivity of the separation can be further optimized.

Preferably, the separation gas is directed in a zigzag flow. This is defined to mean, that the main direction of flow of the separation gas undergoes multiple changes, however, is always directed upwardly. Individual stages of the gravity separation are formed at the changes in direction of the separation gas, with which the selectivity of the method can be further increased.

Preferably, the ionized gas is added to the separation gas at at least two stages or changes in direction of the zigzag flow. Thereby, the discharge of the plastic particles can be specifically adjusted to the respective stages of the zigzag flow and selectivity can be further improved.

Preferably, plastic flakes are separated by air separation into a fine fraction and a coarse fraction. It is thereby possible to separate similar particles that differ not in terms of their basic material, but only in terms of their shape and/or size, for subsequent processing. This is to be seen in contrast to the separation method, wherein only impurities, such as adhering dust or fibers, are to be separated from a particular material. However, this does not exclude that, for example, additionally surface impurities are separated from the starting material together with the fine fraction, which then can be separated in super fine particle filters or the like from the fine fraction. The separation according to the disclosure of PET flakes, originating from crushed plastic bottles and differing in size and/or thickness, is particularly advantageous, as the separation into differently fine fractions here simultaneously enables the separation of material portions which during the bottle production were stretched to a varying degree and therefore are of a different crystalline structure, or the like.

Preferably, the plastic particles to be separated are a fraction originating from a material separation method having been separated using active electrostatic particle charging. Such methods charge different plastic materials, for example, in a controlled opposite manner, so that they can be separated electrostatically. This is known, for example, for separating PET and PVC from each other. Thus pretreated particles can therefore be charged with a particularly high electrostatic charge at the beginning of the air separation.

However, the plastic particles to be separated could also have been passively charged, i.e. inadvertently, during transportation of the material prior to the air separation, for example, by friction of the particles against the pipe wall, friction of the particles among each other, or the like.

Preferably the plastics particles are composed of R-PET flakes, at least 50% by weight. Separation of R-PET flakes is particularly advantageous for subsequent processing, as different fractions, such as light fractions and heavy fractions, can have different material properties due to the earlier manufacturing processes. For example, flakes from the neck area and the bottom area of blown bottles exhibit a relatively low crystallinity due to the lacking or low stretching of these areas during their stretch blow molding.

The object posed is also satisfied by a gravity separator for plastic particles according to the disclosure, which in one form comprises a separation duct for guiding blown-in separation gas from below upwardly and in the counter stream against the plastic particles to be separated. An ionization apparatus for ionizing a portion of the separation gas is likewise provided. The portion is in particular a gas ionized by the ionization apparatus, which is after ionization introduced into the separation gas.

Preferably, the gravity separator is designed as a zigzag separator. This improves selectivity of the separation compared with a linear riser separator.

Preferably, separate ionization apparatuses are provided at least at two stages of the zigzag separator. Discharge of the plastic particles can thereby be controlled in a particularly specific and efficient manner. In this, a plurality of nozzles can be provided at a single stage of the zigzag separator for introducing ionized gas, which are fed, for example, by a common ion generator.

An ionization apparatus is preferably provided in the region of a lower blow-in line for the separation gas. This allows adding the ionized gas in a particularly simple manner. Such an ionization apparatus in the region of the blow-in line could be specifically complemented by ionization apparatuses at various stages of the zigzag separator.

Preferably, at least two separately adjustable ion generators are provided. In this manner, the required ionization level can be accurately and efficiently adjusted to the plastic particles to be separated.

Nozzles with a variable main direction of flow are preferably provided for introducing the ionized gas. The distribution of the ions for compensating the electrostatic charge of the plastic particles can therewith be specifically adjusted to the respective flow conditions in the separation duct. This is especially advantageous in the region of the individual stages of a zigzag separator.

### BRIEF DESCRIPTION OF THE DRAWINGS

A preferred embodiment of the disclosure is illustrated in the drawing.

FIG. 1 shows a schematic representation of the flows of the separation gas and an ionized gas through the device according to the disclosure;

FIG. 2 shows a schematic side view through a gravity separator according to the disclosure with a zigzag flow; and

FIG. 3 shows an oblique view of the gravity separator from FIG. 2.

### DETAILED DESCRIPTION OF THE PREFERRED EMBODIMENT

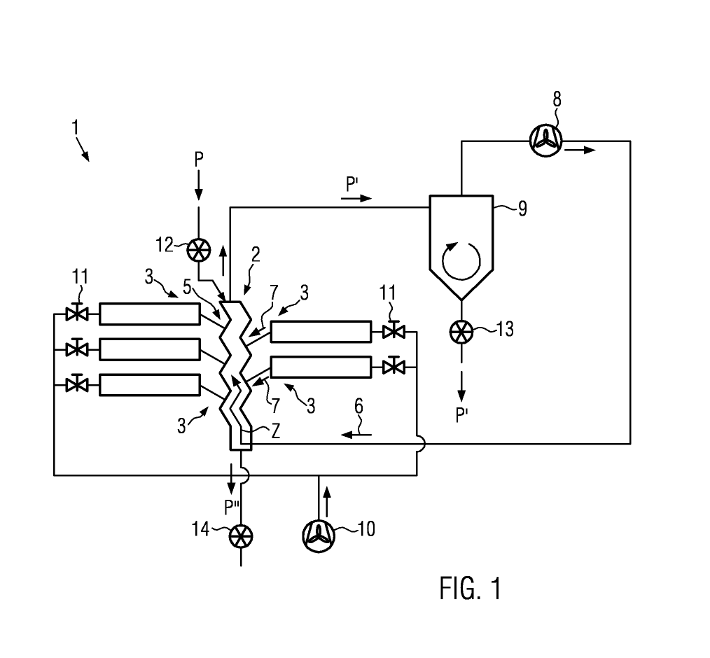

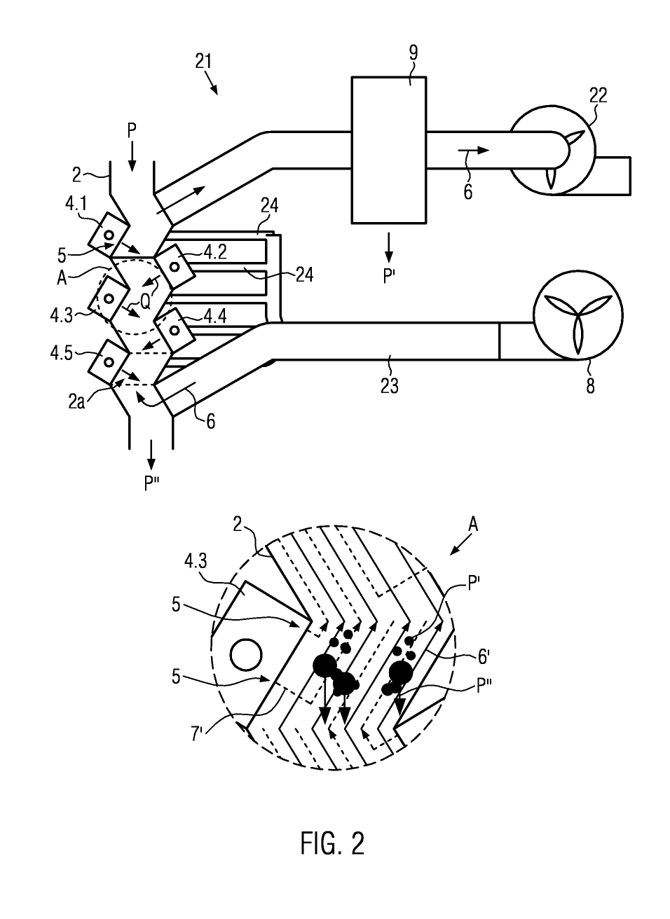

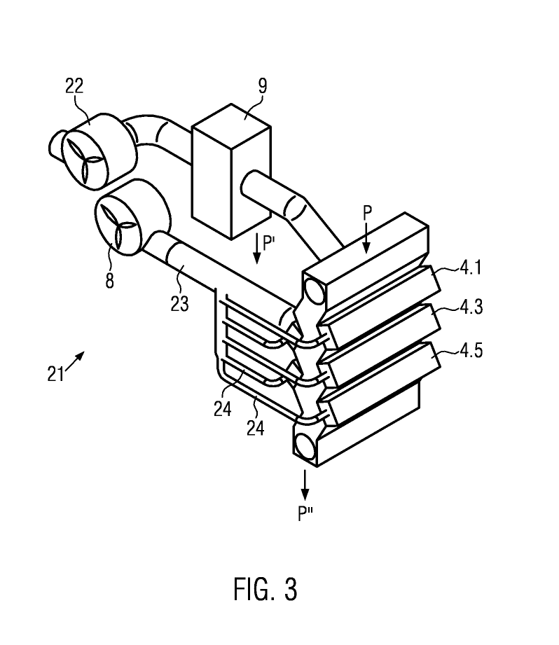

As shown in FIG. 1, a first embodiment 1 of the gravity separator according to the disclosure for plastic particles P comprises a separation duct 2, to which the ionization apparatuses 3 are connected. They comprise, for example, ion generators 4.1 to 4.5 shown in FIGS. 2 and 3 and inlet nozzles 5 connected thereto and leading into the separation duct 2. The separation duct 2 has separation gas 6 flowing through essentially in the counter stream to gravity, i.e. from below upwardly. Ionized gas 7 is generated by each ionization apparatus 3 and introduced into the separation duct 2 substantially in the transverse stream Q to the separation gas 6. The separation gas 6 and the ionized gas 7 are preferably air and can, for example, be obtained from room air and/or ambient air. The ion generators 4.1 to 4.5 then serve in particular to generate ionized oxygen from the air.

The separation gas 6 is with a first blower 8 blown into the lower region of the separation duct 2. The separation gas 6 can for this purpose be guided in a circuit, for example, in that it is returned to the first blower 8 downstream of the separation duct and fines separator 9 for separating a fine fraction P′ of the plastic particles P from the separation gas 6. However, such a circuit is not mandatory. Furthermore, schematically indicated are a second blower 10 with which air is blown through the ionization apparatuses 3, valves 11 for adjusting the individual flow rates through the ionization apparatuses 3, and conveyor devices 12 and 14 for feeding the plastic particles P to be separated, for conveying the fine fraction P′, and for conveying a coarse fraction P″ of the plastic particles P accumulating in a known manner at the lower end of the separation duct 2.

The directions of the inlet nozzles 5 for the ionized gas 7 are preferably adjustable, in particular independently of each other. As further shown in FIG. 1, the separation duct 2 preferably has a zigzag shape, so that, in the separation duct 2, a schematically indicated zigzag flow Z of the separation gas 6 is formed, which extends upwardly with multiple changes of the main direction of flow 6′ of the separation gas 6.

For a better understanding of the mode of operation, the separation duct 2 can be subdivided into a plurality of separation duct stages 2a, each limited by the change in direction of the main direction of flow 6′. This is indicated in FIG. 1 for one of the stages 2a with dashed lines. They are preferably, but not necessarily, allocated separately actuatable ionization apparatuses 3. For example, each separation duct 2a can be allocated its separate ion generator 4.1 to 4.5 and a group of inlet nozzles 5. It would also be conceivable to supply at least two separation duct stages 2a using a common ion generator. Between the latter and the inlet nozzles 5, a separate valve for adjusting a partial flow rate can be provided in the respective separation duct stage 2a for each of the separation duct stages 2a thus supplied (not shown). Separate adjustment of the ion supply in the individual separation ducts stages 2a is advantageous in any case, for example, by adjusting the respective introduced flow rate and/or the ion concentration of the ionized gas 7 introduced into the respective separation duct stage 2a. The number of changes in direction of the zigzag flow Z or the number of stages 2a of the separation duct 2 is only shown by way of example.

The second embodiment 21 of the gravity separator according to the disclosure schematically illustrated in FIG. 2 differs from the first embodiment 1 by the guidance of the air supply and the air discharge. According thereto, the second embodiment 21 is provided with a separate blower 22 for extracting the separation gas 6 downstream of the fines separator 9. With the first blower 8, the separation gas 6 is blown through a main supply line 23 into the separation duct 2. Auxiliary supply lines 24 branch off therefrom in the direction of the ion generators 4.1 to 4.5, to blow air into them as well. There are preferably several transverse streams Q of ionized gas 7 provided successively in relation to the separation gas stream. The valves 11 indicated in FIG. 1 or the like can be provided at the auxiliary supply lines 24 for adjusting the respective flow rate (not shown in FIG. 2).

A center region A of the separation duct 2 is shown enlarged in FIG. 2. According thereto, the main direction of flow 6′ of the separation gas (solid arrows) essentially follows the shape of the separation duct 2. The main direction of flow 7′ of the inflowing ionized gas 7 (broken arrows) respectively extends transversely to the main direction of flow 6′ of the separation gas 6. The individual ion generators 4.1 to 4.5 can each be allocated multiple inlet nozzles 5, of which, for reasons of clarity, only two inlet nozzles 5 of the center ion generator 4.3 illustrated enlarged in FIG. 2 are shown. The inlet nozzles 5 can according to the schematic representation of FIG. 1 also be connected via connecting lines to the ion generators 4.1 to 4.2.

The illustrated embodiments 1, 21 are formed as zigzag separators, which—as known—have improved selectivity over simple riser separators with a substantially linear vertical separation gas stream. The ionization according to the disclosure, however, could also be applied in such a riser separator in an advantageous manner.

The ionized gas 7 is added to the separation gas 6 preferably in the separation duct 2, but could also at least in part be introduced together with the separation gas 6 via the main supply line 23 and/or be generated in the bottom region of the separation duct 2, below the lowermost separation duct stage 2a.

As shown enlarged in FIG. 2, the ionization according to the disclosure and the resulting reduction of electrostatic charges on the plastic particles P promotes the separation of fine fraction P′ from the coarse fraction P″. For the purpose of illustration, the size difference between the fractions is exaggerated in FIG. 2. Using the ionization, the fine fractions P′ and the coarse fractions P″ of the same material, in particular made of PET, which differ only relatively slightly with respect to their size and/or shape, can be separated from each other. In particular, PET flakes of varying size can be separated with sufficient selectivity into a fine fraction, for example, parts of bottle walls stretched during stretch-blowing, and a coarse fraction, for example, parts of bottle openings unstretched during stretch blowing.

The main direction of flow 7′ of the ionized gas 7 does not need to be aligned exactly perpendicular to the main direction of flow 6′ of the separation gas 6 as is indicated schematically in FIG. 2. For example, the direction of the nozzles 5, and thereby the main direction of flow 7′ of the respectively inflowing ionized gas 7, can be adjustable. Thereby, optimized flow conditions for the ionized gas 7 and the separation gas 6 can be specifically created in different regions of the separation duct 2, in particular, in the individual separation duct stages 2a.

FIG. 3 illustrates the line arrangement 21 in the embodiment of the disclosure with the main supply line 23 for the separation gas 6 and the auxiliary supply lines 24 for the ion generators 4.1 to 4.5 for air supply.

The gravity separator according to the disclosure can be used as follows:

A flow of plastic particles P to be separated is introduced into the separation duct, for example, using the upper conveyor device 12 such that the plastic particles P to be separated can freely fall into the separation duct 2 and/or be freely flowed against by the upwardly streaming separation gas 6.″ Plastic particles of the fine fraction P′ adhering to the plastic particles of the course fraction P″ due to electrostatic attraction can, due to the ionizing according to the disclosure of at least a portion of the gas flowing through the separation duct 2, detach from the particles of the coarse fraction P″. Consequently, the particles of the fine fraction P′ are in the separation duct 2 collected by the separation gas 6 and discharged upwardly in the direction of the filter 9 from the separation duct 2. Plastic particles of the heavy fraction P″ fall against the inflowing separation gas 6 downwardly from the separation duct 2. There they can be discharged, for example, with the lower conveyor device 14.

By having streaming the plastic particles P with ionized gas 7, and in particular transversely to the main direction of flow 6′ of the separation gas 6, the electrostatic charge decreases such that the plastic particles P of the same material, in particular PET flakes, can be specifically and with predetermined selectivity separated into a coarse fraction and a fine fraction.

The main direction of flow 7′ at the individual nozzles 5 are there like the respective flow rates of the ionized gas 7 selectively adjusted to the desired flow conditions and the given size distribution of the supplied plastic particles P.

The embodiments described can presently be combined, for example, various ion generators, air supply lines and/or valves. Likewise, pre-ionized separation gas can already be introduced in the lower inlet region of the separation duct and/or separately ionized gas can be added.

1. A method for gravity separation of plastics particles, comprising guiding separation gas upwardly in the counter stream against the plastic particles to be separated, and wherein the separation gas is at least partially ionized.

2. The method according to claim 1, and adding ionized gas to the separation gas.

3. The method according to claim 2, and adding the ionized gas in at least two transverse streams separately adjustable in terms of the flow rate and/or the main direction of flow of the ionized gas.

4. The method according to claim 3, and introducing the transverse streams successively relative to the main direction of flow of the separation gas.

5. The method according to claim 1, and directing the separation gas in a zigzag flow.

6. The method according to claim 5, and adding the ionized gas to the separation gas at at least two stages of the zigzag flow.

7. The method according to claim 1, and separating by air separation the plastic particles into a fine fraction (P′) and a coarse fraction (P″).

8. The method according to claim 1, wherein the plastic particles to be separated are a fraction from a material separation method having been separated using active electrostatic particle charging.

9. The method according to claim 1, wherein the plastics particles are composed of at least 50% by weight R-PET flakes.

10. A gravity separator for plastic particles, comprising:
a separation duct for guiding blown-in separation gas from below upwardly and in the counter stream against the plastic particles to be separated; and
at least one ionization apparatus for ionizing a portion of the separation gas.

11. The gravity separator according to claim 10 being formed as a zigzag separator.

12. The gravity separator according to claim 11, wherein separate ionization apparatuses are provided at at least two stages of the separation duct.

13. The gravity separator according to claim 11, and an ionization apparatus provided in the region of a lower supply line for blowing in the separation gas into the separation duct.

14. The gravity separator according to claim 10, where at least two separately adjustable ion generators are provided.

15. The gravity separator according to claim 10, wherein nozzles with an adjustable main direction of flow are provided for introducing the ionized gas.

16. The method according to claim 1, wherein the plastics particles are plastic flakes.

17. The method according to claim 2, and adding the ionized gas to the separation gas in the transverse stream relative to the main direction of flow of the separation gas.

18. The gravity separator according to claim 10, wherein the plastic particles are plastic flakes.
